(19) United States
(12) Patent Application Publication
(10) Pub. No.: US 2002/0198822 A1
(43) Pub. Date: Dec. 26, 2002

(54) Method and apparatus for evaluating an application for a financial product

(76) Inventors: Rodrigo Munoz, Fairfield, CA (US); Daniel Tom, Streamwood, IL (US)

Correspondence Address: BUCKLEY, MASCHOFF, TALWALKAR, & ALLISON, 5 ELM STREET, NEW CANAAN, CT, 06840, US

(21) Appl. No.: 09/886,919

(22) Filed: Jun. 21, 2001

(51) Int. Cl. G06F 17/60

(52) U.S. Cl. 705/38

(57) ABSTRACT

A system and method of evaluating an application for a financial product includes receiving application data. Expected loss data are calculated, based at least in part on the application data. A return on investment for the application is then calculated based at least in part on the expected loss data. The calculated return on investment is then compared to an expected return on investment for the financial product to make an approval decision.

### CROSS-REFERENCE TO RELATED APPLICATIONS

This application is related to commonly-owned U.S. patent application Ser. No. ______, filed Jun. 21, 2001 (on even date herewith), Attorney Docket No. G03.012 for “METHOD AND APPARATUS FOR RISK BASED PRICING”, and U.S. patent application Ser. No. ______, filed Jun. 21, 2001 (on even date herewith), Attorney Docket No. G03.013 for “METHOD AND APPARATUS FOR MATCHING RISK TO RETURN”, the contents of each of which are incorporated by reference in their entirety for all purposes.

### FIELD OF THE INVENTION

The present invention relates to methods and apparatus for making decisions regarding the approval of financial applications.

### BACKGROUND OF THE INVENTION

Financial institutions offer a wide variety of different financial products to consumers and other entities (“applicants”). These products, such as loans or leases, are approved or disapproved based on information regarding a particular applicant and other information relating to the transaction. Particularly with respect to financial products offered to consumer applicants, financial institutions traditionally make approval decisions based primarily on the applicant's credit risk. Typically, an application for a financial product is received and “scored” using one or more credit risk models. Typical credit risk models include proprietary modes or fee-based models such as those offered by Equifax, Experian, or Trans Union (each of which generate so-called “FICO” scores based on a model developed by Fair, Isaac).

Use of these models, however, still requires that one or more individuals at the financial institution be given the final authority to approve a financial application. For example, an individual credit manager at a financial institution may be authorized to utilize his or her best judgment to make a final approval or disapproval of a consumer loan application after it has been scored using one or more credit risk models. That is, the credit manager uses his or her judgment to determine whether to, for example, lend money to an individual applicant with a given credit score. Unfortunately, this process can lead to inconsistent lending practices from a return on investment standpoint (e.g., one credit manager may approve a loan to an individual with a marginal FICO score which could result in a low return, while another manager may deny a similarly-situated individual).

Some consistency of application has been achieved through the use of tiered products. For example, a financial institution which provides leases for automobiles may establish several tiers of lease products, each having different criteria for eligibility, one of which is related to the applicant's credit score. This allows differential pricing of products based on historical performance within each product, and also eliminates some of the inconsistency of approvals which can result from blanket reliance on the discretion of credit managers.

However, there could be high risk deals within a tier, especially when the risk is near the tier cutoff. For certain types of financial products, there could also be collateral risk (e.g., where the collateral is an automobile, a particular automobile may have a faster than average depreciation rate). By simply approving or disapproving applications based on credit risk and loss risk calculations, the return on investment for a particular application may not be maximized. Further, too many applications must be approved manually. This can be a drain on resources and can lead to inconsistent application of approval standards.

It would be desirable to provide a system and method which reduces the amount of manual approval required in the financial application approval process. It would further be desirable to provide a system and method which allows a financial institution to maximize its return on investment for financial products, such as loans and leases. It would further be desirable to provide such a system which is automated and which allows remote interaction over public or private networks.

### SUMMARY OF THE INVENTION

To alleviate the problems inherent in the prior art, and to provide an improved decision making tool for approving or declining financial applications, embodiments of the present invention provide a system, apparatus, method, computer program code and means for evaluating an application for a financial product.

In one embodiment, a system, apparatus, method, computer program code and means for evaluating an application for a financial product includes receiving application data. Expected loss data are calculated, based at least in part on the application data. A return on investment for the application is then calculated based at least in part on the expected loss data.

According to one embodiment, the expected loss data are calculated using one or more loss models. In one embodiment, an account level loss forecast model is used in conjunction with a termination event model to calculate an expected loss over the life of a product for which an application has been received. According to one embodiment, the calculated return on investment for the application is compared with one or more expected returns on investment for the financial product to determine whether to approve or disapprove the application.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a flow diagram depicting a process for evaluating an application for a financial product according to one embodiment of the present invention;

FIG. 2 is a block diagram of a system consistent with the present invention;

FIG. 3 is a block diagram of a lender device of the system of FIG. 2 pursuant to an embodiment of the present invention;

FIG. 4 is a table depicting an exemplary applicant database used in the system of FIG. 2;

FIG. 5 is a table depicting an exemplary tier database used in the system of FIG. 2;

FIG. 6 is a table depicting exemplary loss estimate data used in the system of FIG. 2; and

FIG. 7 is a flow diagram depicting a process for evaluating an application for a financial product according to a further embodiment of the present invention.

### DETAILED DESCRIPTION OF THE INVENTION

Applicants have recognized that there is a need to further reduce uncertainty in decisions regarding the approval of financial products. In particular, Applicants have recognized that there is a need to allow lenders to establish and enforce expected returns on investment (ROI) for particular financial products.

For the purposes of describing embodiments of the present invention, a number of terms will be used herein. As used herein, the term “financial institution” will be used to refer to a bank, credit union, or other lender or entity which extends credit to or otherwise underwrites financial products to applicants. As used herein, the term “lender” may be used interchangeably with the term “financial institution”. As used herein, the term “applicant” is used to refer to an individual or entity which is applying for approval of a financial product offered by a financial institution. As used herein, the term “financial product” is used to refer to a loan, lease, or other item of credit extended by a financial institution to an applicant. As used herein, the term “price” is used to refer to a fee or other cost of funds of a financial product which will be received by the financial institution if an application is approved. Example “prices” include the annual percentage rate (APR) received by a financial institution for a loan, or basis points received by a financial institution for a lease product. Other types of “prices” are known to those skilled in the art.

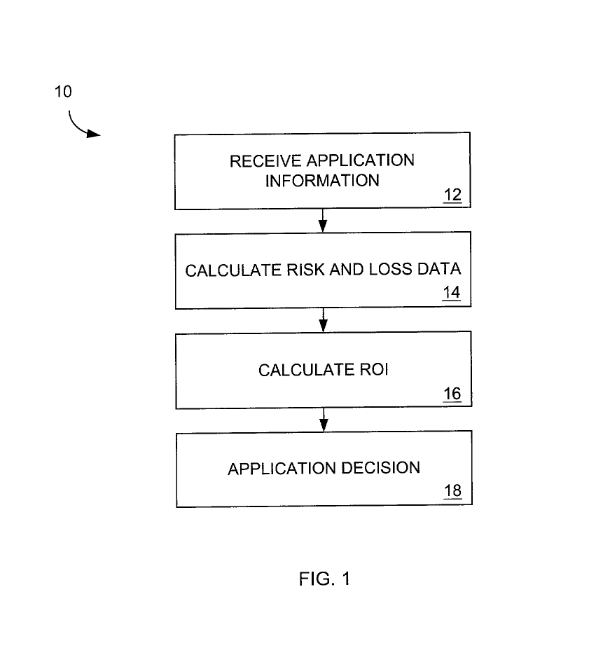

Referring now to FIG. 1, a process 10 is shown according to one embodiment of the present invention. Process 10 may be conducted by, or on behalf of, a financial institution to allow the financial institution to make application approval decisions according to embodiments of the present invention. In particular, process 10 provides a method by which the financial institution can establish and utilize target return on investment (ROI) factors in the approval process for a financial product.

Process 10 begins at 12 where application information is received. This application information may be received directly from an applicant for a financial product such as a loan or a lease, or it may be received from an intermediary, such as a loan officer at a car dealership. The nature and extent of the application information received may vary depending on the particular needs of the financial institution and also depending on the nature of the financial product for which approval is sought. In general, application information received at 12 may include information identifying the application, information identifying collateral to be pledged in security of the financial product, and information regarding the financial aspects of the application.

For example, where the financial product is a car lease, the application information received may include: the applicant's social security number and contact information, a vehicle identification number (VIN) of the vehicle being leased, mileage information regarding the vehicle being leased, the amount of the requested lease, etc. Other information relating to the applicant's credit may also be received at this time, such as a credit rating of the applicant. This credit rating and other credit information may be received from a third party, such as a commercial credit rating service such as the service offered by Experian or Fair, Isaac. In one embodiment, the credit rating may be represented, for example, by a so-called “FICO” credit score. In other embodiments, the credit information may be generated after receipt of the application information. Those skilled in the art will recognize that any of a number of rating systems may be used, and that a combination of one or more systems may also be used to generate credit information used with embodiments of the present invention.

Once this application information has been received, processing continues at 14 where the system of the present invention operates to calculate risk and loss data for the particular applicant and for the particular financial product requested. For example, these risk and loss calculations may include calculations determining the probabilities of a number of different termination events occurring during the life of the financial product (e.g., early payoff of a lease, etc.). These risk and loss probabilities are transformed into financial loss numbers for the particular product. In particular, a gross loss severity for each month of the expected term of the financial product is generated.

Processing continues at 16 where a return on investment (ROI) for the application based on the requested financial product is calculated. In particular, the ROI calculated is based on the expected net income (NI) and the annualized net investment (ANI) is calculated, taking into account the gross loss severity calculated at 14. Once this ROI for the application is generated, processing continues at 18 where a decision to approve or not to approve the application is made by comparing the calculated ROI with a stored expected ROI for the particular product. In one embodiment, a number of expected ROIs are established by the financial institution based on different product tiers. At 18, the calculated ROI is compared with the expected ROI established by the financial institution for the particular financial product which is the subject of the application.

A financial institution's expected ROI may be established in any of a number of ways. In one embodiment, the expected ROI is based on historical portfolio performance. In other embodiments, the expected ROI is established using techniques described in commonly-assigned and co-pending U.S. patent application Ser. No. ______, filed______(on even date herewith), Attorney Docket No. G03.013 for “METHOD AND APPARATUS FOR MATCHING RISK TO RETURN”.

The result is a system and method which further reduces the number of judgment calls which must be made in financial product approval processes, and which allows an entity to establish and enforce expected ROI objectives for a variety of types of financial products. Further details and alternatives of each of these process steps will be described further below.

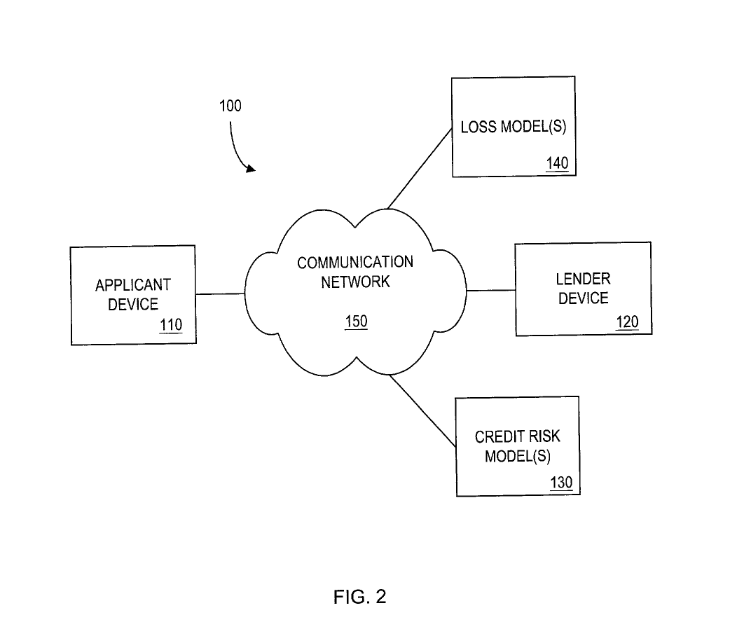

Referring now to FIG. 2, a system 100 pursuant to one embodiment of the present invention is shown. System 100 includes at least one applicant device 110 in communication with at least one lender device 120. Lender device 120 is in communication with one or more credit risk and loss model(s) 130, 140.

As used herein, devices (such as applicant device 110 and lender device 120) may communicate, for example, via a communication network 150, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology. Security measures, known to those skilled in the art, may be used with embodiments of the present invention to ensure data security and privacy as data is moved between devices and stored at devices such as devices 110 and 120.

In one embodiment of the present invention, each applicant device 110 communicates with one or more remote, World Wide Web (“Web”)-based lender devices 120 (e.g., configured as a Web-server) via the Internet. Although some embodiments of the present invention are described with respect to information exchanged using a Web site, according to other embodiments information can instead be exchanged, for example, via: a telephone, an Interactive Voice Response Unit (IVRU), electronic mail, a WEBTV® interface, a cable network interface, and/or a wireless communication system.

Applicant device 110 and lender device 120 may be any devices capable of performing the various functions described herein. For example, either of applicant device 110 and lender device 120 may be, for example: a Personal Computer (PC), a portable computing device such as a Personal Digital Assistant (PDA), or any other appropriate computing, storage and/or communication device.

Note that although a single applicant device 110 and a single lender device 120 are shown in FIG. 2, any number of applicant and/or lender devices 110, 120 may be included in system 100. In one currently preferred embodiment, system 100 will include a plurality of applicant devices 110 in communication with one or more lender devices 120. Similarly, any number of the other devices described herein may be included in 100 according to embodiments of the present invention. Note that the devices shown in FIG. 2 need not be in constant communication. For example, applicant device 110 may only communicate with lender device 120 via the Internet when appropriate (e.g., when an applicant for a financial product of a lender desires to submit an application for approval pursuant to the present invention).

Further note that applicant device 110 need not be operated by the individual applicant applying for a financial product. Instead, applicant device 110 may be operated on behalf of the individual applicant by, for example, a lender agent or another entity. Similarly, lender device 120 need not be operated by the financial institution offering the financial product for which an application is received; instead, lender device 120 may be operated on behalf of the lender by a service provider or other agent of the financial institution.

Credit risk and loss model(s) 130, 140 may be data stores or may be devices operated by third party service providers. Model(s) 130, 140 may also be model(s) established by and operated by or on behalf of the lender operating lender device 120. A number of different model(s) may be used in conjunction with embodiments of the present invention. These models, as will be described more fully below, are used in embodiments of the present invention to first identify a particular product tier for a given application, and then to generate an estimate of an expected loss for the application.

Any of a number of different types (and combinations) of models may be used. For example, a credit risk model 130 such as the models offered by Experian or Fair, Isaac may be used to generate a FICO score for a particular applicant. These credit risk models typically generate an assessment of an applicant's future risk of non-payment. Other proprietary and fee-based systems may also be used in conjunction with embodiments of the present invention. Data from one or more credit risk models 130 are used to identify an applicant's eligibility for one or more financial products as will be described further below.

One or more loss models 140 may also be used in conjunction with embodiments of the present invention. Those skilled in the art will recognize that a number of different proprietary and commercial systems have been developed for different types of financial products. In an embodiment used in conjunction with automobile financial products, such as vehicle leases or loans, account-level loss forecast models may be used which factor in the risk of one or more major termination events occurring. For example, for vehicle leasing, four early termination events may be considered: repossession, early payoff, insurance loss, and early turn-in (or “quasi-repossession”). One or more loss models 140 estimating the risk of occurrence of these events may be used in an embodiment of the present invention used to assist in the approval of vehicle lease applications. Other examples will be described further below.

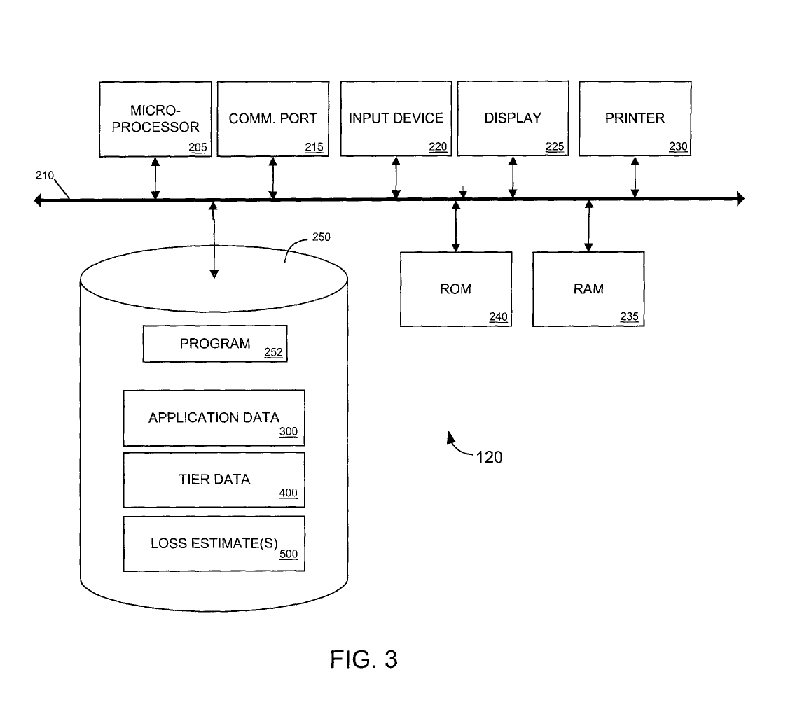

Details of one embodiment of lender device 120 will now be described by referring to FIG. 3 which is a block diagram of the internal architecture of an illustrative lender device 120. As illustrated, lender device 120 includes a microprocessor 205 in communication with a communication bus 210. Microprocessor 205 may be a Pentium, RISC-based, or other type of processor and is used to execute processor-executable process steps so as to control the elements of lender device 120 to provide desired functionality.

Also in communication with communication bus 210 is a communication port 215. Communication port 215 is used to transmit data to and to receive data from external devices, such as applicant device 110, and/or model(s) 130. Communication port 215 is therefore preferably configured with hardware suitable to physically interface with desired external devices and/or network connections. In one embodiment, applications for financial products are received from applicant device 110 via the Internet through communication port 215.

An input device 220, a display 225 and a printer 230 are also in communication with communication bus 220. Any known input device may be used as input device 220, including a keyboard, mouse, touch pad, voice-recognition system, or any combination of these devices.

Display 225, which may be an integral or separate CRT display, flat-panel display or the like, is used to output graphics and text to a user in response to commands issued by microprocessor 205. Such graphics and text may comprise a user interface as described herein. Printer 230 is an optional output device that produces a hardcopy of data using ink-jet, thermal, dot-matrix, laser, or other printing technologies. Printer 230 may be used to produce a hardcopy of application data or other data produced by or used with embodiments of the invention.

A random access memory (RAM) 235 is connected to communication bus 210 to provide microprocessor 205 with fast data storage and retrieval. In this regard, processor-executable process steps being executed by microprocessor 205 are typically stored temporarily in RAM 235 and executed there from by microprocessor 205. A read-only memory device (ROM) 240, in contrast, may be provided to permit storage from which data can be retrieved but to which data cannot be stored. Accordingly, ROM 240 is used to store invariant process steps and other data, such as basic input/output instructions and data used during system boot-up or to control communication port 215.

A data storage device 250 stores processor-executable process steps comprising a program 252. Microprocessor 205 executes processor-executable process steps of program 252 in order to perform the functions set forth herein.

The data stored in data storage device 250 may be in a compressed, uncompiled and/or encrypted format. Furthermore, stored in data storage device 250 may be program elements that may be necessary for operation of server 200, such as an operating system and “device drivers” for allowing microprocessor 205 to interface with devices in communication with communication port 215. These program elements are known to those skilled in the art, and need not be described in detail herein.

Data storage device 250 also stores (i) an applicant database 300, (ii) a tier database 400, and (iii) loss estimate(s) data 500. The databases and data stores are described in detail below and depicted with exemplary entries in the accompanying figures. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

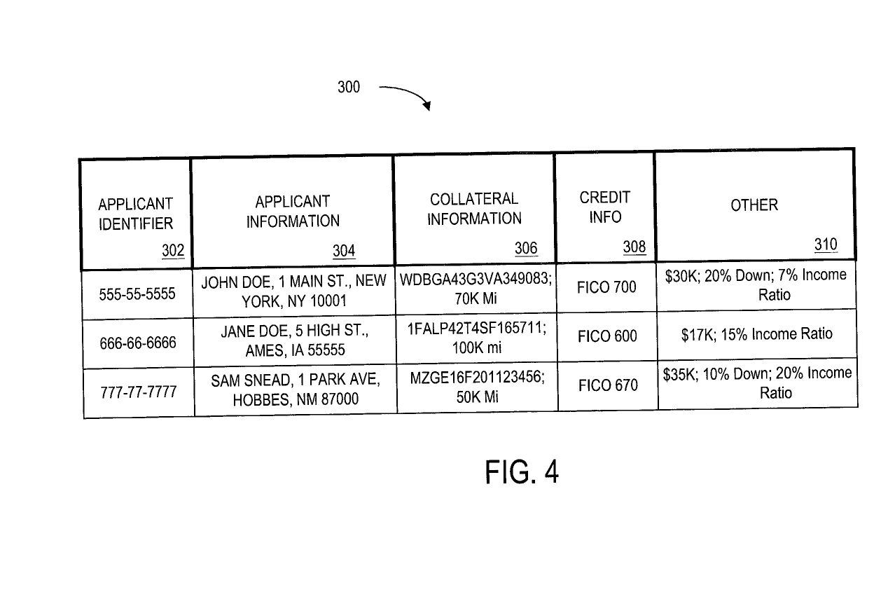

Referring now to FIG. 4, a table is shown representing application database 300 that may be stored at or accessible to lender device 120 according to an embodiment of the present invention. The table includes entries identifying particular applications which have been received for approval using techniques of the present invention. The table also defines a number of fields 302-310 for each of the entries. The fields specify: an applicant identifier 302, applicant information 304, collateral information 306, credit information 308, and other information 310. The information in database 300 may be created and updated, for example, based on information received from individual applicant devices 110. The information in database 300 may also be based on, for example, application information received via mail, telephone or other communication mediums and then entered into database 300.

Applicant identifier 302 may be, for example, an alphanumeric code associated with a particular applicant who has submitted an application for approval via system 100. In one currently-preferred embodiment, applicant identifier 302 is an individual's social security number or an entity's federal tax identification number.

Applicant information 304 may include information identifying the applicant such as, for example, the applicant's name and address and other contact information.

Collateral information 306 may include information particularly identifying one or more items of collateral which are intended to secure a financial product if the application is approved. For example, where the collateral is a vehicle such as an automobile, the collateral information may include a vehicle identification number (VIN) and mileage information for the particular automobile. Other information may also be provided to further identify the item (or items) of collateral.

Credit information 308 includes information identifying, for example, a credit score or other information indicating the credit worthiness of the applicant identified by applicant identifier 302. This information may be provided by credit risk model(s) 130. A number of proprietary and fee-based credit scoring models are known in the art and may be used to provide credit information 308.

Other information 310 may include other data used to identify the particular application to be approved or disapproved using techniques of the invention. For example, the amount of money to be financed, an amount of a down payment (if any), information identifying the applicant's payment to income ratio, information identifying the applicant's total debt ratio, or the like may be provided in field 310. Those skilled in the art will recognize that a number of other types of information may also be provided in database 300 to assist system 100 in making an approval decision. Further, the example datasets shown in FIG. 3 (as well as the other figures to be discussed) relate to automobile financial products. Those skilled in the art will recognize that other types of financial products may also benefit from techniques of the present invention.

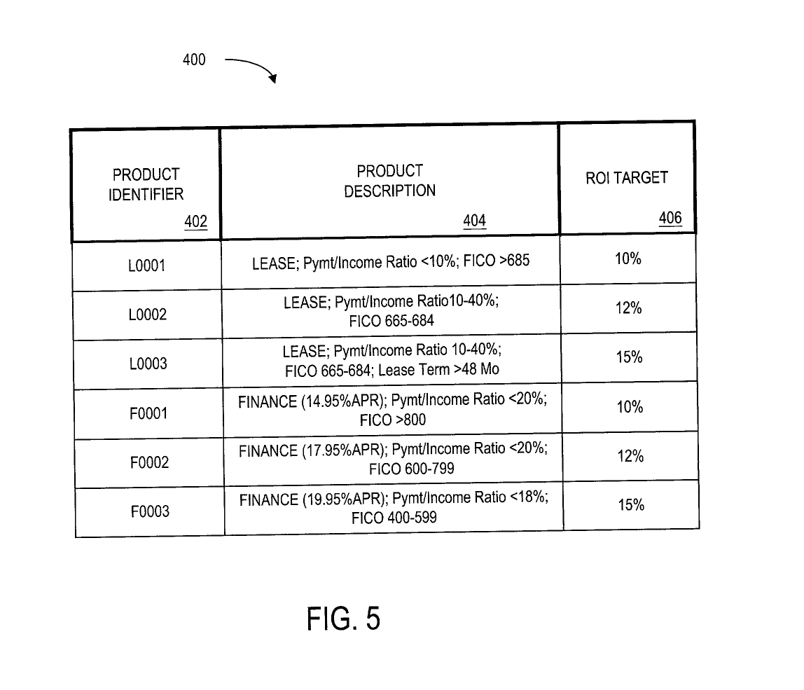

Referring now to FIG. 5, a table is shown representing tier database 400 that may be stored at or accessible to lender device 120 according to an embodiment of the present invention. The table includes entries identifying particular product tiers which have been established by a lender. In the exemplary table of FIG. 5, three tiers of lease products and three tiers of loan products are shown for automobiles. The table also defines fields a number of fields 402-406 for each of the entries.

The fields specify: a product identifier 402, a product description 404, and a ROI target 406. The information in database 400 may be periodically specified and updated by a lender to establish different financial product tiers and ROI targets for those tiers. Each type of product (in the examples used herein, a lease and a loan are different product types) may have different ROI targets established by the lender. For example, leases may be broken into three product types, one for individuals having excellent credit. A lower ROI may be acceptable for this product than for a lease intended for individuals presenting a higher credit risk. The product identifier, description and ROI target may be modified by a lender as needed to adjust to market fluctuations and other factors. The established ROI target or hurdle may be generated in a number of ways by the lender. One desirable approach is described in commonly-owned, co-pending U.S. patent application Ser. No. ______, filed on even date herewith, for “METHOD AND APPARATUS FOR MATCHING RISK TO RETURN”, (Attorney Docket No. G03.013).

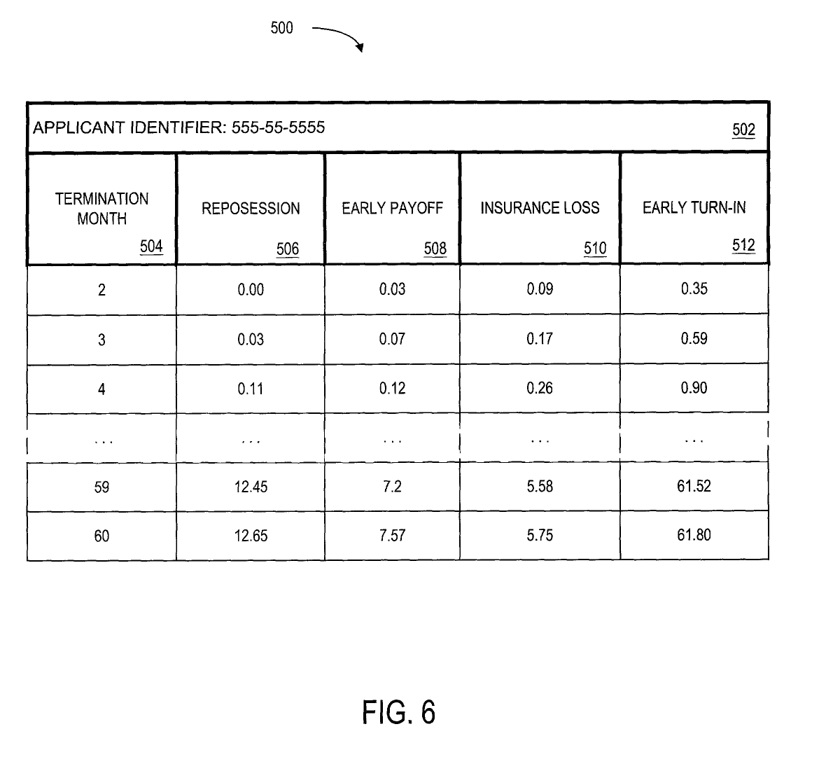

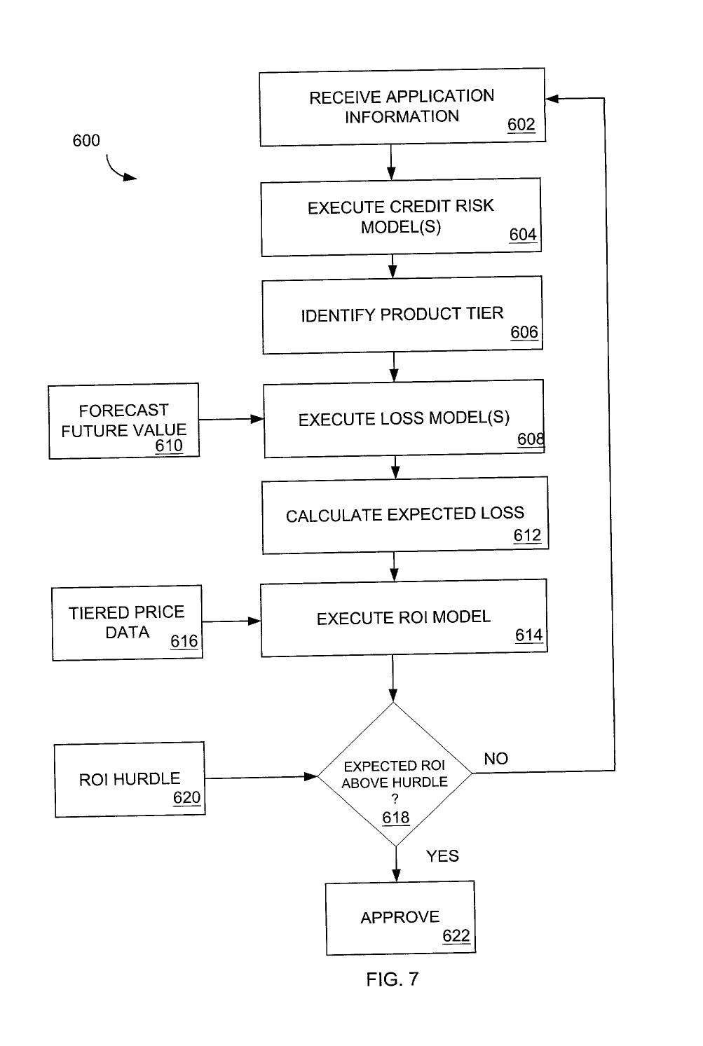

Referring now to FIG. 6, a table is shown representing loss estimate(s) data 500 that may be generated by lender device 120 according to an embodiment of the present invention. The table includes data entries calculated using input from loss model(s) 140 to estimate the probability of losses occurring as a result of early termination of a product for which an application has been received. The table includes a number of fields 502-512 for each of the entries. The table of FIG. 6 is an example of a table generated for an application for an automobile lease. The fields included in the example include an applicant identifier 502 (preferably the same as or relating to the applicant identifier 302 of FIG. 4), a termination month 504 (representing each month of a lease product; the example is for a 60-month lease), and several termination scenarios 506-512 (repossession, early payoff or “quasi-repossession”, insurance loss, and early turn-in). The values in each of the fields 506-512 are estimates generated using one or loss more model(s) 140, and will be described more fully below in conjunction with a description of the process of FIG. 7.

The data represented by the table of FIG. 6 are presented here for illustrative purposes only. Those skilled in the art will recognize that other types and formats of data may also be used, depending on the type of financial product for which approval is sought. Further, this data is used in an intermediate calculation step and need not be permanently stored in system 100. Once the data represented by the table of FIG. 6 has been generated, further calculations are performed to generate individual loss severity dollar amounts for each month and for each termination scenario. The monthly loss severity dollar amounts are generated based on the expected market value of the collateral for each termination scenario compared to the book balance of the collateral for each scenario. A subsequent table may be generated (not shown) to represent these dollar amounts.

Similar tables (not shown) may be generated to present loss data for an automobile loan. In such an example, different termination events may be calculated, including, for example: repossession, non-collateralized loss and early pay-off. Models known to those skilled in the art may be used to estimate loss probabilities for each month of the loan.

Referring now to FIG. 7, a process 600 is shown. Process 600 is one embodiment of a process for approving financial applications according to one embodiment of the present invention. Process 600 may be performed under the direction of program 252 of lender device 120 (as shown in FIG. 3, for example). In some embodiments, portions of process 600 may be performed by different devices to achieve the result of an approval decision. To facilitate understanding of features of the present invention, an example will be described in conjunction with a description of FIG. 7. In the example, an applicant is an individual consumer requesting approval of an automobile lease.

Processing begins at 602 where application information is received. This application information may include the information stored at application database 300 (FIG. 4) and may be received from applicant device 110. Information received at 602 includes information necessary to identify the applicant, the financial product requested, and collateral information (if any). For example, the individual consumer applying for an automobile lease may submit (or have an agent submit) application information including: the consumer's name and address, the consumer's social security number or federal tax identifier, information identifying the automobile (including the VIN and mileage information), and other information identifying the nature of the lease (e.g., 20% down, 7% income ratio, etc.). This information may be stored in application database 300.

Processing continues at 604 where one or more credit risk models are executed based on the received application information. For example, in the automobile leasing illustration, a credit risk model (such as credit risk model 130 of FIG. 2) may be executed to determine a risk of repossession of the vehicle (e.g., based on applicant's default of the lease terms). This credit risk model may result in the generation of a credit risk score (such as a FICO score or other score) which is stored in application database 300. Applicants have found that further calibrating the credit risk model by using the actual frequency of repossession over the first 24 months of automobile leases (or loans) has been useful to achieve greater accuracy in the forecasting of portfolio losses.

The credit risk score may be used to identify an appropriate product tier at 606. For example, some products, such as automobile leases and loans, may be aggregated into different pricing tiers or categories. An example of tier pricing may be seen by referring to FIG. 5, where three tiers of lease products (L0001-L0003) and three tiers of loan products (F0001-F0003) are shown. Each tier is established by the lender based on, for example, loss data for each type of product. For example, an applicant for an automobile lease may qualify for tier L0001 if his payment to income ratio is less than 10% and if his FICO score is greater than 685. This lease product may have greater features than products in other tiers because the applicant who qualifies for this tier is a relatively low risk applicant. A lender may modify these tiers on a regular basis.

Once a product tier has been identified at 606, processing continues to 608 where one or more loss model(s) are executed (such as loss model(s) 140 of FIG. 2). The nature of the model(s) executed at this step will depend on the nature of the financial product for which an application has been received. For example, an application for an automobile loan will likely require the execution of a different model than an application for an automobile lease. Processing at 608 is performed to estimate, over the life of a financial product, the likelihood that the lender will suffer a loss prior to the natural termination of the product. A number of different loss models have been developed for various types of financial products. For example, losses may be modeled based on the use of historical data for similar applicants and similar products. Statistical models may utilize other data, such as actuarial data, to estimate losses for particular types of products.

Data such as a future value of a vehicle (generated in step 610) may also be provided to loss models at 608. In an embodiment used in conjunction with automobile leasing or financing, Applicants have found that estimation of the future value of a vehicle used as collateral for a lease or loan may be performed using any of a number of known techniques. For example, the technique referred to as “Winter's Multiplicative Seasonal Time Series” forecasting method may be used. As another example, a technique calculating an exponential decay between the vehicle's manufacturer suggested retail price (MSRP) and the residual value at the end of term may be used as well. Those skilled in the art will recognize that other techniques may also be used to facilitate the forecasting of potential losses.

An example will be provided by referring to FIG. 6, where a table shows a set of loss estimates for a particular applicant 502 who has applied for approval for a lease product. Because automobile leases are generally considered as having four early termination scenarios, table 500 shows loss estimates for each of the four scenarios (repossession, early payoff, insurance loss, and early turn-in). These loss estimates are provided for each month during the term of the lease product (here, over 60 months). Given the risk, the term, and whether the collateral vehicle is new or used, loss models may be used to generate an estimated probability for each termination scenario for a given application.

For example, if the lease term is 60 months, the model generates 60 different loss probabilities for each of the four termination events. Together with full term (no loss), there are 241 scenarios for this example. Applicants have found that, as compared to payment volatility, these premature termination events can be easier to model. Only the distinct month-event scenarios need be considered in many cases, versus the Monte Carlo methods which may be used to simulate payment volatility. Nevertheless, any of a number of different loss estimation techniques may be used.

Each of the loss estimates are calculated using the system referred to as “Cox Regression” analysis. Where historical and/or actuarial data is available and useful, this may be used to augment the Cox Regression analysis. As can be seen in the example of FIG. 6, repossessions and early turn-ins (especially later in the life of the product) are a big portion of potential losses that a lender may face.

A similar table of expected loss probabilities might be generated for an application for an automobile loan, except that the early termination scenarios for a loan are slightly different than the early termination scenarios for a lease. Early termination scenarios for a loan may include: repossession, non-collateralized loss, and early payoff. Those skilled in the art will recognize that lenders utilize a number of loss models to estimate the probability of loss for each of these scenarios. These and other models may be used to estimate a likelihood of loss for other products such as loans.

Once loss model(s) have been executed at 608 (and loss probability data such as the example data of FIG. 6 have been generated), processing continues to 612 where an expected loss for the application is calculated. This expected loss, or gross loss severity, is calculated for each scenario generated by the loss model(s) at 608. Using collateral information and other data from the application (stored, e.g., in application database 300), the current balance on-book is calculated (e.g., using simple interest) from the amount financed to the end-of-term residual value. The market value for the collateral is then calculated for the particular termination scenario. The Winter's Model referred to above may be used to estimate the future market value. The difference between the book value and the market resale value is the gross loss severity. Processing at 612 calculates the gross loss severity for each month on book for which a potential termination event may occur.

Processing continues at 614 where a potential return on investment (ROI) is calculated. For each month's loss scenario, the calculated gross loss severity and the tier price are fed into a ROI model along with other data regarding the particular application. The ROI model then calculates the net income (NI) and annualized net investment (ANI) for each of the termination events as well as the full term event. The potential ROI is calculated by taking the ratio of the expected NI to the expected ANI.

This calculated potential ROI is compared to an established ROI target or hurdle received at 620 (e.g., from tier database 400 of FIG. 5) to determine if the potential ROI which will be realized for a given application exceeds the ROI target for that particular product. If the potential ROI exceeds the ROI target or hurdle, the application is approved at 622. The established ROI target or hurdle may be generated in a number of ways by the lender. One desirable approach is described in commonly-owned, co-pending U.S. patent application Ser. No. ______, filed on even date herewith, for “METHOD AND APPARATUS FOR MATCHING RISK TO RETURN”, (Attorney Docket No. G03.013), the contents of which are hereby incorporated in their entirety herein for all purposes.

According to one embodiment of the present invention, the application approval decision at 622 may be communicated to the applicant or an agent of applicant via communication network 150 (FIG. 2). If the potential ROI does not exceed the ROI target or hurdle, the application is declined. Processing may revert to 602 where the application is resubmitted. In some embodiments, room for a manual decision to approve may be built-in to the process by allowing a manual decision to be made for applications which fail to meet the ROI target, but which are within a predetermined range (e.g., within 10% of the target), or based on other factors (e.g., based on information regarding the lender's volume targets, etc.).

According to one embodiment of the present invention, product tiers and pricing decisions may be augmented with yield management techniques to provide further assistance in pricing. According to one embodiment of the present invention, product tiers are selected, where appropriate, with information collected from surveys conducted periodically. For example, prices for different risk segments (quantified by credit risk models) are generated. In one embodiment, a funding to approval ratio (FTAR) is obtained for different prices. This provides a probabilistic quantity to manage net income. The expected net income is FTAR multiplied by the net income at a given price. The price that gives the maximum expected net income may be selected as the price for a given risk segment for a given product. This information may be used to establish pricing for different tiers. This selected price may not necessarily fall within the target ROI for the product, in which case the lender may choose to either relax the target ROI or disapprove the application. In either event, such surveys will allow the lender to have a more clear understanding of the competitive marketplace so that it may more appropriately respond to applicants.

Although the present invention has been described with respect to a preferred embodiment thereof, those skilled in the art will note that various substitutions may be made to those embodiments described herein without departing from the spirit and scope of the present invention.

What is claimed is:

1. A method of evaluating an application for a financial product, the method comprising:
receiving application data;
calculating, based at least in part on said application data, expected loss data; and
calculating, based at least in part on said expected loss data, a return on investment for said application.

2. The method of claim 1, further comprising:
making an application approval decision based on said return on investment.

3. The method of claim 2, wherein said making an application approval decision further comprises:
comparing said return on investment with an expected return on investment.

4. The method of claim 1, wherein said application data includes at least one of a collateral identifier, credit related information, and payment information.

5. The method of claim 1, wherein said calculating expected loss data comprises:
executing an account level loss forecast model;
executing a termination event model; and
calculating expected loss data in response to the execution of the account level loss forecast model and the execution of the termination event model.

6. The method of claim 5, wherein said executing an account level loss forecast model further comprises:
calculating a future value for an item of collateral associated with said application.

7. The method of claim 1, wherein said calculating expected loss data further comprises:
storing price tier data;
executing a risk model to compute a credit risk;
assigning said credit risk to a price tier based on said price tier data; and
generating probabilities of one or more of said termination events occurring before said expiration to form one or more termination scenarios.

8. The method of claim 7, wherein said calculating a return on investment further comprises:
forecasting the severity of loss of said termination scenarios to form one or more loss scenarios;
calculating net income and annualized net investment for said loss scenarios;
determining expected net income and expected annualized net investment in response to said calculating; and
determining an expected return on investment based on a ratio comprising said expected net income and said expected annualized net investment.

9. The method of claim 7, wherein said generating probabilities further comprises:
generating probabilities of said termination events occurring in relation to a plurality of said payment times.

10. The method of claim 8, wherein said forecasting the severity of loss further comprises:
forecasting the severity of loss of said termination scenarios for at least a plurality of said payment times.

11. The method of claim 7, wherein said financial product requires an item of collateral and wherein said forecasting comprises:
forecasting a current balance on book;
forecasting a market value of said collateral; and
calculating a difference between said current balance on book and said market value of said collateral.

12. The method of claim 11, wherein said forecasting a market value is performed using at least one of: Winter's multiplicative time series estimation; or an exponential decay between a manufacturer suggested retail price of said collateral and a residual value of said collateral at the expiration.

13. The method of claim 7, wherein said financial product is a lease.

14. The method of claim 13, wherein said termination events comprise at least one of: repossession with delinquencies, early payoff, insurance loss, and repossession without delinquencies.

15. The method of claim 7, wherein said financial product is a loan.

16. The method of claim 15, wherein said termination events comprise at least one of: repossession, non-collateralized loss and early payoff.

17. A computer-readable medium bearing a computer program containing instruction steps such that upon installation of said computer program in a general purpose computer, the computer is capable of performing the method of claim 1.

18. A method of evaluating an application for a financial product for which at least one price tier has been established, the method comprising:
receiving application data;
executing a risk model to compute a credit risk for said application data;
assigning said credit risk to a price tier; generating probabilities of one or more termination events occurring before an expiration of said financial product to form one or more termination scenarios;
forecasting the severity of loss of said termination scenarios;
calculating, based at least in part on said severity of loss of said termination scenarios, a return on investment (ROI) for said application; and
approving said application if said calculated ROI is within an expected ROI threshold.

19. An apparatus for evaluating an application for a financial product, the apparatus comprising:
a processor;
a communication device, coupled to said processor, receiving application data from at least a first user device; and
a storage device in communication with said processor and storing instructions adapted to be executed by said processor to:
calculate, based at least in part on said application data, expected loss data; and calculate, based at least in part on said expected loss data, a return on investment (ROI) for said application.

20. The apparatus of claim 18, said storage device further storing instructions adapted to be executed by said processor to:
make an application approval decision based on said calculated ROI.

21. A system for evaluating an application for a financial product for which at least one price tier has been established, the system comprising:
at least a first user device having
a processor;
a communication device, coupled to said processor, configured to send and receive data over a network; and
a storage device in communication with said processor and storing instructions adapted to be executed by said processor to receive application data; and
forward said application data to an at least first lender device said at least first lender device having
a second processor,
a second communication device, coupled to said second processor, configured to send and receive data over said network and to receive said application data; and
a second storage device in communication with said second processor and storing instructions adapted to be executed by said second processor to
execute a risk model to compute a credit risk for said application data;
assign said credit risk to a price tier;
generate probabilities of one or more termination events occurring before an expiration of said financial product to form one or more termination scenarios;
forecast the severity of loss of said termination scenarios;
calculate, based at least in part on said severity of loss of said termination scenarios, a return on investment (ROI) for said application; and
approve said application if said calculated ROI is within an expected ROI threshold.

22. A computer program product in a computer readable medium for evaluating an application for a financial product, comprising:
first instructions for receiving application data;
second instructions for calculating, based at least in part on said application data, expected loss data;
third instructions for calculating, based at least in part on said expected loss data, a return on investment (ROI) for said application; and
fourth instructions for approving said application if said calculated ROI is within an expected ROI range for said financial product.

23. A system for evaluating an application for a financial product, the system comprising:
means for receiving application data;
means for calculating, based at least in part on said application data, expected loss data; and
means for calculating, based at least in part on said expected loss data, a return on investment for said application.

24. The system of claim 23, further comprising means for comparing said return on investment with an expected return on investment; and means for making an application approval decision based on said return on investment.
